(19) United States
(12) Patent Application Publication
(10) Pub. No.: US 2004/0163067 A1
(43) Pub. Date: Aug. 19, 2004

(54) Method and apparatus for layout of high speed digital logic for datapath portions of microprocessor integrated circuits

(76) Inventors: Robert Jared Migliore, Fort Collins, CO (US); John Andrew Francis Cloudman, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/366,430

(22) Filed: Feb. 13, 2003

(51) Int. Cl. G06F 9/45; G06F 17/50

(52) U.S. Cl. 716/10

(57) ABSTRACT

A method of creating a layout of high speed logic includes extracting dimensions of logic elements from a logic element library. A first logic element is placed in the layout and a second logic element is placed relative to the first logic element. The second logic element is placed according to a relative placement attribute. Additional logic elements are autoplaced according to the logic design. Interconnect is then autorouted between the logic elements according to the logic design. In many embodiments, the second logic element is placed by adding a dimension of the first logic element and an offset specified by the relative placement attribute to the location of the first logic element. In embodiments, components may contain hierarchy with relatively placed logic elements within them. In these embodiments, a minimum dimension for a first component is computed from logic element dimensions and placements within the component. Additional components containing or comprising logic elements are placed by adding a minimum dimension of the first component to an offset specified by the relative placement attribute and the location of the first component. Also disclosed are embodiments where critical signal paths, such as bus and/or clock lines, are prerouted.

### FIELD OF THE DISCLOSURE

The present application relates to methods and apparatus for design of layout for high-speed integrated circuits. The methods and apparatus are of particular utility in layout of digital datapaths; such as are used in high-speed microprocessor and digital signal processor integrated circuits. In particular, the method and apparatus are applicable to placement of logic elements and/or interconnect in layouts of high-speed integrated circuits.

### BACKGROUND

Speed of logic gates within integrated circuits is often highly dependent upon details of layout.

The dependence of speed on details of layout is in part because resistance and capacitance increase with the length of each connection between logic elements. The greater the resistance and capacitance, the greater the delay associated with the logic elements and connection. Capacitance, and in some processes resistance, are a function of the layers used for each connection as well as the length and width of the connection. It is therefore advantageous to use short connections on appropriate layers in constructing high-speed logic. It can also be advantageous to use wider interconnect for critical connections.

For purposes of this application, a logic element is a logic gate, flip-flop, adder, or other portion of a digital logic design that may be independently placed and routed during the design of layout for the circuit. The logic design may be extracted from a schematic prepared by a design engineer. The logic design may also be derived by a synthesis system from a model prepared in a hardware description language such as Verilog or VHDL. Synthesis systems are commercially available from Cadence Design, Synopsys, and others. The hardware description language model, hereinafter HDL model, is typically prepared by a design engineer.

Many synthesis tools map data storage, such as declared with Verilog “reg” statements, to logic elements in a way that produces logic elements having consistent and predictable instance names. Vector data storage is typically mapped to logic element instance names by appending to a base instance name a separator character and a sequence number for each logic element associated with the vector. Most synthesis tools map non-storage circuitry to logic elements having names that change each time the tool is run.

Hand layout of integrated circuits is possible, and typically takes good advantage of circuit architecture and structure, including regularity of structure, known to design engineers responsible for the logic design. Layouts resulting from hand layout can have the necessary short interconnects for high-speed performance.

Modern microprocessor designs have enormous numbers of logic elements; modern processors may have 200 million or more transistors on one integrated circuit. Manual layout of circuits of this complexity can be very expensive and time consuming. In order to complete these designs in reasonable time, or to make design revisions in reasonable time, is necessary to use high speed computers to automatically place many of these logic elements and route many of the interconnections between them. Software for automatic placement and routing of logic elements, known as place and route software, is commercially available from a variety of sources, including Cadence Design and Synopsys. Commercial place and route software runs on a variety of computers including those made by Hewlett Packard. A place and route system includes both place and route software and computers to run the software.

Place and route systems typically include a placer module that determines a physical location in an integrated circuit layout for each logic element of the design. Placer modules use cell abstracts from a cell library to indicate physical dimensions of each logic element, these dimensions are used during placement. Once a location for each logic element has been determined, a routing module routes connections between the logic elements according to the logic design.

Lengths of routed connections, and therefore final circuit speeds, are highly dependent on the physical locations determined for the logic elements. It is therefore desirable to determine placements of logic elements that are as near optimum as possible, such that the final design can meet speed requirements.

Many high-speed datapath designs, such as used in processor circuits, incorporate data busses. Each line of these busses may have many connections. Because of the large number of connections, and the potential length (and delay) of interconnect if bus lines are inefficiently laid out, it is particularly important that bus lines be laid out with short lengths. For bus lines to lay out with short lengths, it is desirable that circuitry associated with the bus lines be placed along the bus lines.

High-speed datapath designs typically also have at least one clock line, and often have one or more control lines. These lines may also require careful layout to control delay. Delay on clock lines contributes to clock skew, and excessive clock skew can cause nonoperation of logic.

A logic design is typically presented as a netlist to a place and route system. A netlist is typically a text file including for each logic element a logic element type, a logic element instance name, and wire names indicating the required connections to that logic element. Common netlist formats include Spice, VHDL, and Verilog formats. Netlists may also be used to present a logic design to circuit and logic simulation systems. A netlist may be in the form of a single file, or may be a collection of files containing the logic element types and connectivity information.

Many placer modules operate through a cut-line method. Cut-line methods operate by determining a series of vertical and horizontal cut-lines across the layout. A count of connections crossing each cut-line is made, then circuit elements are exchanged across the cut line when an exchange reduces the number of connections crossing the cut-line, or otherwise improves the layout. Cut-line methods may be used to optimize an initial layout. In some placer modules, the initial layout is generated by randomly placing circuit elements, then optimizing with a cut-line method.

Simulated annealing is a method of iteratively optimizing placement of circuit elements and/or interconnect in a layout. When used for placements, this method operates by scoring placements of a layout, then making random changes in the placements and determining scores for the resulting modified layouts. Scoring may involve grading multiple features of the layout including interconnect lengths and interconnect congestion. Resulting layouts that have improved scores are retained for further iterations of optimization.

Genetic placement optimization methods are also known. These methods also operate iteratively. These methods create multiple descendant layouts by randomly mutating and recombining features from parent layouts. The descendent layouts are scored; good scoring layouts have a higher probability of being retained as parent layouts for further generations than poor scoring layouts. After several generations, a “best” scoring layout is selected. Both simulated annealing and genetic methods rely on efficient and accurate scoring of layouts.

Cut-line, simulated annealing, and genetic methods may be combined. There are other placement and placement optimization methods known.

Placement methods, such as the cut-line, simulated annealing, and genetic methods, typically do not take advantage of design engineer's knowledge of circuit structure and architecture.

While a combination of cut-line, simulated annealing, and genetic algorithms can produce quality placement for simple circuits lacking logical structure, improvement is necessary for high-speed circuits having regular structure such as high performance processor circuits. Experiment shows that with these algorithms a minor logic change may cause substantial changes in layout and circuit performance—therefore much experimentation can be required to get good layout after logic changes. Improvement is particularly necessary for datapath circuits.

Some place and route systems permit manual placement of logic elements. These place and route systems are capable of autoplacing logic elements not manually placed and autorouting interconnect of the design. These place and route systems typically require entry of coordinates for each manually placed logic element, which can be very time consuming for large circuits.

Some placer modules permit manual placement of some or all logic elements. These modules typically use a placement file containing logic element instance names; each instance name paired with layout coordinates. These placer modules place logic elements for which locations are specified, then they place and optimize placement of remaining logic elements of the design. Some placer modules also permit use of area constraints for placement. Area constraints allow an engineer to direct placement of portions of a design into particular sections of a layout, without specifying coordinates of each logic element.

Typically, placer modules that permit manual placement require a file having fully specified instance names of each manually-placed logic element. These placer modules typically require that element placements be specified as X and Y coordinates within the layout. In some systems, these coordinates may be specified in terms of grid units; in others, one coordinate may be specified as a row number.

Specification of element locations as X and Y coordinates, whether in metric units, row numbers, or in terms of grid units, can be a laborious, error-prone, and time-consuming process. Furthermore, circuit changes that require relocation of significant portions of circuitry require repetition of this laborious, error-prone, and time-consuming process.

### SUMMARY

A design engineer places relative locality attributes upon selected circuit elements in a schematic of a logic design. These attributes are extracted with connectivity information into a netlist representation of the logic design.

Alternatively, the design engineer places relative locality attributes in the hardware description language model. The hardware description language model is translated into a netlist with a synthesis system, and the relative locality attributes are transferred into this netlist.

In yet another alternative embodiment, the design engineer places relative locality attributes in a separate relative placement file, where each relative locality attribute is associated with an instance name. The instance name of the relative locality attribute is matched to an instance name of the netlist.

A floorplan is generated using a floorplanning utility.

The locality attributes are imported into a preplacer. At least some of the locality attributes incorporate placement of a logic element relative to placement of another logic element. In an embodiment, the logic element dimensions are extracted from a library, and logic elements are preplaced as specified in the relative placement file.

The preplacer generates a partially placed layout that is imported into a commercially available place and route system. The place and route system places remaining logic elements of the design, then routes required interconnections between logic elements.

In an alternative embodiment, the preplacer also preplaces critical signal lines such as high speed bus lines, clock lines, and/or control lines.

It has been found that method herein described gives better layout, with greater consistency when logic changes are made, than fully-automatic layout, while requiring much less labor than required for manual placement.

### BRIEF DESCRIPTION OF THE DRAWINGS

FIG. 1 is a flowchart of a method of generating a layout for high-speed logic.

FIG. 2 is an illustration of logic element placements in a layout.

FIG. 3 is a flowchart of a method for placing elements according to a locality file.

FIG. 4 is a block diagram of a system for generating a layout of high-speed logic.

### DETAILED DESCRIPTION OF THE EMBODIMENTS

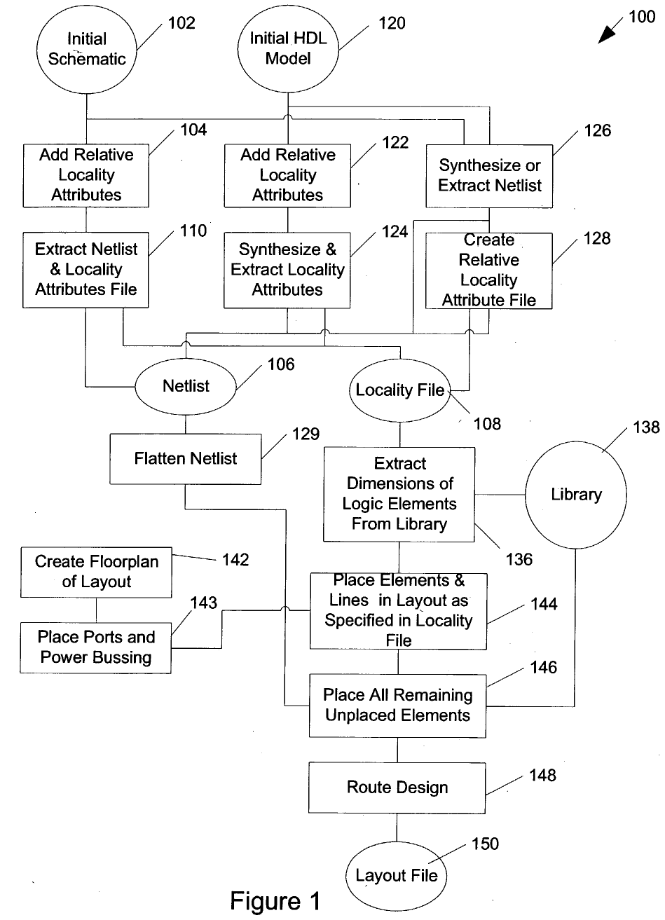

The flowchart of FIG. 1 illustrates a design flow, or method 100, of generating a layout for high-speed logic of an integrated circuit. This method 100 allows part or all of the logic design to be based upon machine-readable schematics 102 such as may be entered into a CAD system like those commercially available from Cadence Design or Mentor Graphics.

In an embodiment, relative locality attributes are added 104 to the schematics 102. A netlist 106 and a relative locality file 108 are extracted 110 from the schematics.

In an alternative embodiment, the method 100 allows part or all of the logic design to be based upon HDL models 120, such as VHDL or Verilog models. Relative locality attributes are added 122 to these models 120. The relative locality attributes are added using a syntax that is interpreted as comments by a simulator, but which may be extracted from the models to create the relative locality file 108. The models 120 are also synthesized 124 by a synthesis tool to create the netlist file 106.

In another alternative embodiment, the netlist 106 and relative locality 108 files are prepared by merging files prepared by extracting 110 schematics and synthesizing 124 HDL models.

In yet another embodiment, the netlist 106 is prepared 126 by synthesizing HDL models or extracting schematics, and a relative locality file 108 is created 128 with a text editor.

The netlist 106 as initially extracted is typically in hierarchical form. The netlist is flattened 129 as known in the art. In an embodiment, the relative locality file 108 is also extracted in hierarchical form.

Dimensions of the logic elements are read 136 from a logic element library 138. A layout floorplan is created 142, specifying dimensions of the block of integrated circuit layout being created. The layout floorplan also specifies the number and orientation of cell rows, including power and ground busses that feed cell rows, and may specify locations of signal connections on the periphery of the layout. Ports, and, in some embodiments, power bussing and power rings are added 143 to the floorplan.

The logic elements specified in the relative locality file 108 are then placed 144 in the layout floorplan. Once these logic elements are placed, preplaced interconnect lines are placed 144 in the layout as specified in the relative locality file.

The layout floorplan, with these logic elements and preplaced interconnect lines placed in it, is transferred into an autoplacer. In a particular embodiment, the autoplacer is the QPLACE component of Cadence Design's Silicon Ensemble design system.

Remaining logic elements are placed 146 in the layout floorplan using the autoplacer. In an embodiment, the autoplacer uses both cut-line and simulated annealing methods to optimize placement of the remaining logic elements. These methods tend to place logic elements near any preplaced logic elements that they are coupled to.

The layout floorplan, with all logic elements now placed, is then routed 148 to generate a routed layout 150.

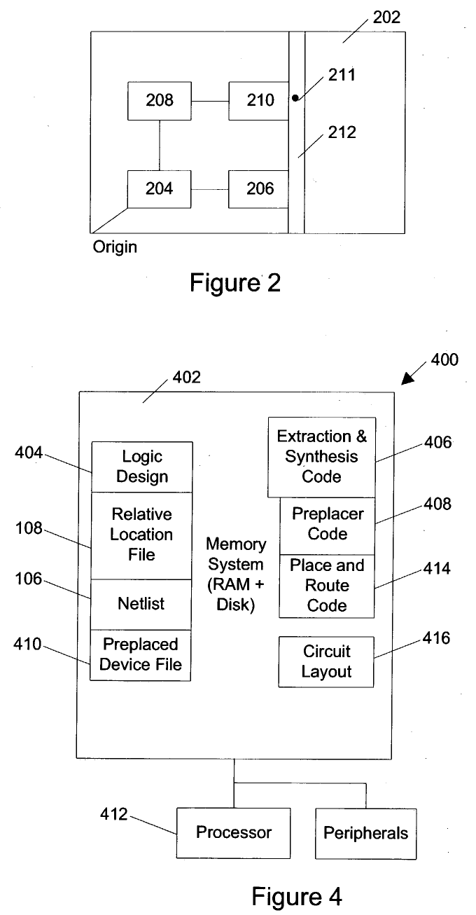

FIG. 2 illustrates an example layout of an integrated circuit showing where circuit elements are placed by the method of FIG. 1. The relative locality file 108 includes specification includes, for each logic element, such as logic element 204 (FIG. 2) placed in layout 202 through relative locality file 108, a logic element orientation (which may be a default orientation). The logic element orientation may include logic element rotation and mirroring. The orientation may include different mirroring orientation for odd and even instances of a logic element.

In an embodiment, a relative location parameter (RLOC) is added 104 to some logic elements, such as logic element 208, of logic schematic 104. This parameter is added using a schematic-editing tool. For a relatively-placed logic element, the RLOC parameter has the following syntax:

REL <relative_location_attribute>

Where the <relative_location_attribute> has format:

```
<rel_instance_name> [<offset>] [X|Y] [<orient>] [<array_orient>] [<array_space>]
<rel_instance_name> is an instance name of another component on the same level
  of schematic. The current logic element is placed relative to this component,
  which may be a logic element or may be an instance of a further level of
  hierarchy.
<offset> is a displacement, which may be represented as units of a spacer cell,
  from the component indicated by rel_instance_name. If this field is missing,
  it is assumed that the current component is placed adjacent to the
  logic elements of the component indicated by rel_instance_name.
X|Y specifies a direction from the rel_instance_name cell for placement of this
  component. If not present, Y is assumed.
<orient> is an optional field describing an orientation of the component, indicating
  whether the component is flipped or rotated.
<array_orient> specifies that, if the component is arrayed, it be placed as
  a vertical or a horizontal row of components. If not present, perpendicular to
  the X|Y direction is assumed.
<array_space> specifies spacing between components as they are arrayed
```

Each component on each schematic page also has an instance_name and a component_type, and may have an array specification. The component_type indicates a type of the component. The instance_name represents a name for a particular instance of the component; typically the instance_name either is a default value or entered by hand. In an embodiment utilizing a Cadence schematic entry system, the array specification, when present, is found within the instance_name in format name[<n1:n2>] where n1 is a number specifying the first element, and n2 a number specifying the last element of the array. Embodiments using other schematic entry systems may represent array specifications in other ways.

A subset of logic elements may be placed with X and Y coordinates relative to an origin of an instance of the hierarchy level in which they are specified. These have RLOC attributes specified with the following syntax:

OFS <offset_location_attribute>

Where the <offset_location_attribute> has format:

[<offset>] [X|Y] [<orient>] [<array_orient>] [<array_space>]

A subset of logic elements may be placed with X and Y coordinates relative to an origin of the layout. These have RLOC attributes specified with the following syntax:

ABS <absolute_location_attribute>

Where the <absolute_location_{—attribute> has format:}

[<location>] [X|Y] [<orient>] [<array_orient>] [<array_space>]

In an embodiment, relative locality file 108 is initially extracted 110 or synthesized 124 in hierarchical form. It includes definitions for multiple levels of the hierarchy. At the lowest level of the hierarchy, the relative locality file includes instances of library cells; at higher levels it includes instances of lower levels of hierarchy and may include instances of library cells. Instances in this file are specified with the following format:

<instance_name>[<array>] <component_type> REL|OFS|ABS

<relative_location-attribute>;

The REL|OFS|ABS, or placement type, field indicates whether instance had a RLOC parameter with the corresponding string and determines whether the instance will be placed relatively, relatively to the origin of an instance of the hierarchy level, or absolutely. The semicolon indicates an end of an instance specification.

When relative locality attributes for data storage elements are specified in a hardware description language such as Verilog, data storage elements may have location attributes specified according to the following syntax:

//RL <Regname> REL|OFS|ABS [<relreg>] X|Y [<orient>] <offset>

Where the “//RL” flags the line as a comment to commonly available Verilog simulators such as Silos-3 or Verilog-XL, and indicates that the line contains a relative locality attribute. The <Regname> field gives a name of the data storage element to be placed as defined in the hardware description language definition of the circuit and as will be found in a netlist generated by a synthesis tool such as Synopsys Design Compiler or Cadence Buildgates. The <Regname> field allows identification of the data storage element type, physical dimensions, and array organization from information in the netlist. The REL|OFS|ABS field indicates whether the data storage element will be placed relatively, relatively to the origin of an instance of the hierarchy level, or absolutely.

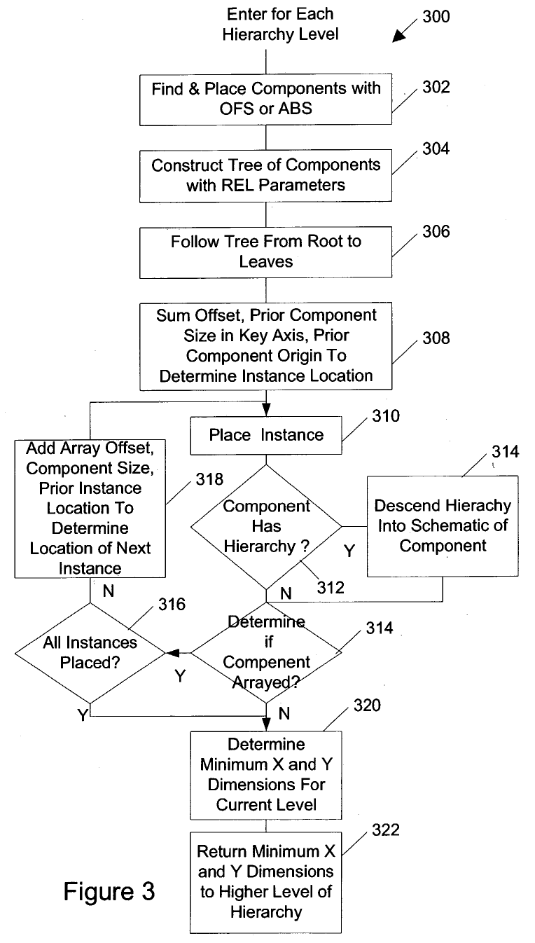

FIG. 3 illustrates a method 300 for placing elements of a level of hierarchy according to a locality file. This method 300 is executed for the top level of the hierarchical circuit description, and for instance of each level of hierarchy beneath the top level; the method forms a major part of the step of placing elements specified in the locality file 144 of FIG. 1.

The present method begins by finding and placing 302 an origin of all components within the current instance of the hierarchy level having locations specified with ABS or OFS placement type. Those components with OFS placement type are placed at a location determined by adding the offset specified in the <offset> field to the origin of the current instance of the hierarchy level.

The method continues by constructing 304 a tree data structure where all components having REL placement type are linked to the component specified by their <rel_instance_name> fields. There may be several trees for the same level of the hierarchy, each tree having a component with OFS or ABS placement type at their root.

Next, the tree structures are followed 306 from root to leaves. Each component in the tree is processed, with origins of components closer to the tree root being determined prior to processing components further from the tree root. For example, if component 204 has an OFS type and component 208 has an REL type, component 204 is processed first.

As each component is processed, a component origin location for component instances having REL type is determined 308 by adding the <offset> field of the instance to the X or Y initial coordinate of the prior instance as determined by the X|Y field, and a X or Y dimension of the previously processed component. For example, if component 208 has an X|Y field of Y, its X component origin coordinate is the initial X coordinate of component 204, while its Y component origin coordinate is the sum of a Y dimension of component 204, the component origin Y coordinate of component 204, and the <offset> field. An instance of the current component is placed 310 at the coordinate calculated.

It is anticipated that components may have additional offsets in the coordinate perpendicular to that herein described and specified by the X|Y field. It is also anticipated that the <offset> field may be left blank, in which case zero is assumed—causing components to be placed adjacent to a previously processed component.

Next, it is determined whether the current component is an instance of a library cell, or an instance of a further level of hierarchy. If it is an instance of a further level of hierarchy, the method recursively descends 314 into that level of hierarchy, and continues by finding and placing 302 components having ABS or OFS placement types in that level. If the component is a library cell, or upon return from processing a further level of hierarchy, it is determined 314 whether the component is an arrayed component. If all required instances of the arrayed component have not yet been placed 316, an additional instance of the component, such as component 210, is placed 310 at a location determined 318 by adding the <array_offset> field and a dimension of the previously placed instance of the arrayed component to either the X or Y coordinate of the previously placed instance of the arrayed component as determined by the <array_orient> field.

When all components having ABS, OFS, or REL placement type within the current level of hierarchy have been placed, minimum X and Y dimensions for the current level are determined 320 and returned 322 to any higher level of the hierarchy. The minimum X and Y dimensions are determined by finding a maximum of the sums of origin coordinates of each component within the current level of hierarchy and the minimum dimensions of each component. Minimum dimensions of logic element, or leaf, components are those extracted 136 from the library.

When all levels of the hierarchy have been processed, execution of the preplacement method 300 ceases, preplaced interconnect lines are placed 144, and remaining components are placed 146 as heretofore described with reference to FIG. 1.

Interconnect lines, such as line 212, may have a relative locality attribute specified as a RLOC attribute in the schematic 102 or in an HDL model 120. These are extracted into the relative locality file 108 along with RLOC attributes of logic elements. As with logic elements, relative locality file 108 may be created 128 with an editor.

Interconnect line specifications in the relative locality file 108 need not specify all aspects and fingers of each interconnect line. For most applications of the method, only a “trunk” of the line is specified in the relative locality file 108 and prerouted, branches are added by the router as the design is routed 148. Interconnect lines, specified in the relative locality file 108 and preplaced, are extended, branched, and expanded as the design is routed 148 such that they connect the logic elements as specified by the netlist 106.

Interconnect line specifications in the relative locality file 108 have the following syntax:

<wire instance name>[ <array>] WIRE <wire_location_attribute> [<width>][<array_space>]

where the <wire_location_attribute> field typically includes a <wire_location> field that specifies a location of a point on the line, and a <wire_direction> field that specifies a direction in which to extend the line.

The location of a point on the line specified by the <wire_location> field may be a pin of the block, or may be specified absolutely, relative to other lines, at a particular wiring channel, or may be a name of a preplaced logic element. When a name of a preplaced logic element is used, this is may be a logic element that connects to the line. When specified as a name of a preplaced logic element that connects, an offset (which may be zero) from the logic element may also be specified.

The direction to extend the line of the <wire_direction> field may be specified as X, for a horizontal line extended left and right, L for extension to the left, R for extension to the right, Y for a vertical line extended up and down, U for extension up, or D for extension down.

The <wire_location_attribute> may include an optional extension limit <wire_extent> field; those lines lacking an extension limit are extended to the block edge. The extension limit may also be specified relative to a perpendicular interconnect line. For example, interconnect line 212 may be preplaced from a point 211 on the line determined by a pin of logic element 210, extended both up and down.

The optional <width> field is specified when it is desired to preplace interconnect lines wider than standard to reduce interconnect resistance.

If the optional <array> field is present, an array of lines will be placed. These lines are distributed perpendicular to the orientation specified in the <wire_direction> of each preplaced interconnect line. These lines are spaced as specified in the <array_space> field.

In an embodiment, interconnect line specifications are used to preplace trunks of interconnect lines for critical bus lines, clock lines, and control of a datapath block. During routing, these trunks are connected to each logic element connected to the line.

A computer program product is any machine-readable media, such as an EPROM, ROM, RAM, DRAM, disk memory, or tape, having recorded on it computer readable code that, when read by and executed on a computer, instructs that computer to perform a particular function or sequence of functions. A computer system having memory, the memory containing code for executing the heretofore-described method for priority encoding and vectoring to interrupts, is a computer program product.

FIG. 4 illustrates a system 400 for performing layout of an integrated circuit. In this system, a memory system 402, including disk and RAM memory systems as known in the art, contains a logic design 404 as a schematic 102 and/or HDL model 104. The memory system also contains synthesis and/or extraction code 406 for deriving a netlist 106. A relative placement file 108, also contained in memory system 402, is created as heretofore described. Preplacer code 408, including code for performing the method 300 for performing relative placement, is also located in memory system 402, this code when executed on a processor 412 coupled to memory system 402, places 144 logic elements in the layout 416 and records these placements in preplaced device file 410. Memory system 402 also includes code 414 for automatic placement 146 of remaining components and routing 148 the design as the layout 416 is completed.

While the forgoing has been particularly shown and described with reference to particular embodiments thereof, it will be understood by those skilled in the art that various other changes in the form and details may be made without departing from the spirit and hereof. It is to be understood that various changes may be made in adapting the description to different embodiments without departing from the broader concepts disclosed herein and comprehended by the claims that follow. In particular, it is expected that alternative syntax may be used to specify relative locality information.

What is claimed is:

1. A method of creating a layout of high speed logic according to a logic design comprising the steps of:
extracting dimensions of a plurality of logic elements from a logic element library, the plurality of logic elements including a first logic element and a second logic element, both of which are specified by the logic design;
placing the first logic element in the layout and placing at least the second logic element relative to the first logic element according to a relative placement attribute;
autoplacing additional logic elements according to the logic design; and
autorouting interconnect between the plurality of logic elements according to a netlist of the logic design;
wherein the second logic element is placed at a location determined by adding an offset to a location of the first logic element.

2. The method of claim 1, wherein the second logic element is placed at a location determined by steps comprising adding a dimension of the first logic element to a location of the first logic element

3. The method of claim 1, further comprising the steps of:
extracting the relative placement attribute from a machine-readable schematic; and
extracting a netlist describing at least a portion of the logic design from the machine-readable schematic.

4. The method of claim 1, further comprising the steps of
extracting the relative placement attribute from a hardware description language model, and
synthesizing a netlist describing at least a portion of the logic design from the hardware description language model.

5. The method of creating a layout of high speed logic of claim 4, further comprising the steps of:
extracting a second relative placement attribute from a machine-readable schematic;
extracting a netlist describing a portion of the logic design from the machine-readable schematic;
merging the synthesized netlist and the extracted netlist into the netlist of the logic design, and
placing a third logic element according to the second relative placement attribute.

6. The method of claim 5, further comprising the step of preplacing at least part of at least one interconnect line.

7. The method of claim 1, further comprising the step of preplacing at least part of at least one interconnect line.

8. The method of claim 7, wherein the step of preplacing at least part of at least one interconnect line places an end of the at least part of one interconnect line at a location determined by a location of a placed logic element.

9. A method of creating a layout of high speed logic according to a logic design comprising the steps of:
extracting dimensions of a plurality of logic elements from a logic element library, the plurality of logic elements including a first logic element and a second logic element;
placing the plurality of logic elements according to relative locality attributes;
autoplacing additional logic elements according to the logic design; and
autorouting interconnect between the plurality of logic elements according to the logic design;
wherein at least one logic element is an arrayed logic element, and wherein locations for at least one instance of a logic element of the arrayed logic element is determined by adding an array offset to a location of an initial instance of the arrayed logic element.

10. A method of creating a layout of high speed logic according to a logic design, the logic design having a plurality of levels of hierarchy, comprising the steps of:
within a first level of hierarchy of the logic design, placing an origin of a first component having a second level of hierarchy;
placing the first logic element in the layout relative to the origin of the component and placing at least the second logic element relative to the first logic element according to a relative placement attribute, the first and second logic element comprising portions of the second level of hierarchy of the logic design;
autoplacing additional logic elements according to the logic design; and
autorouting interconnect between the plurality of logic elements according to a netlist of the logic design;
wherein the second logic element is placed at a location in the layout determined by steps further comprising adding an offset to a coordinate of the first logic element.

11. A method of creating a layout of high speed logic according to a logic design, the logic design having a plurality of levels of hierarchy, comprising the steps of:
extracting dimensions of a plurality of logic elements from a logic element library, the plurality of logic elements including a first logic element and a second logic element;
within a first level of hierarchy of the logic design, placing an origin of a first component having a second level of hierarchy;
placing the first logic element in the layout relative to the origin of the component and placing at least the second logic element relative to the first logic element according to a relative placement attribute, the first and second logic element comprising portions of the second level of hierarchy of the logic design;
autoplacing additional logic elements according to the logic design; and
autorouting interconnect between the plurality of logic elements according to a netlist of the logic design;
wherein the second logic element is placed at a location in the layout determined by steps further comprising adding an offset to a coordinate of the first logic element.

12. The method of creating a layout of high speed logic according to a logic design of claim 11, further comprising the steps of:
calculating minimum dimensions of the second level of hierarchy;
returning the minimum dimensions of the second level of hierarchy to the first level of hierarchy; and
placing a third logic element in the first level of hierarchy according at a location determined by adding at least one dimension of the minimum dimensions of the second level of hierarchy to at least one coordinate of the first logic element.

13. The method of creating a layout of high speed logic according to a logic design of claim 12, further comprising the steps of:
preplacing at least one interconnect line at a location determined by adding an offset to a location of the second component, and
extending the line.

14. The method of creating a layout of high speed logic according to a logic design of claim 13, further comprising the steps of:
stopping the step of extending the line at an intercept of the line with a second line.

15. The method of creating a layout of high speed logic of claim 13, wherein the at least one interconnect line has a first width, and further comprising the step of preplacing a second interconnect line having a second width.

16. The method of creating a layout of high speed logic according to a logic design of claim 12, further comprising the steps of:
autoplacing additional logic elements; and
autorouting interconnect to couple the logic elements according to a logic design.
